(19) United States
(12) Patent Application Publication
(10) Pub. No.: US 2025/0153619 A1
(43) Pub. Date: May 15, 2025

(54) INVISIBLE TRIM COVER TIE-DOWN

(71) Applicant: Lear Corporation, Southfield, MI (US)

(72) Inventors: Shifeng ZHANG, YangPu District Shanghai (CN); Yao YAO, YangPu District Shanghai (CN); Jing XU, YangPu District Shanghai (CN); Yong YANG, YangPu District Shanghai (CN); Chandrashekar SIMHA, YangPu District Shanghai (CN)

(73) Assignee: Lear Corporation, Southfield, MI (US)

(21) Appl. No.: 18/829,612

(22) Filed: Sep. 10, 2024

(30) Foreign Application Priority Data
Nov. 15, 2023 (CN) 2023115209729

(51) Int. Cl. B60N 2/60; B60N 2/58

(52) U.S. Cl. CPC B60N 2/6081; B60N 2/5891

(57) ABSTRACT

The application relates to an invisible cover tie-down. A retainer is used to attach a trim cover to a seat cushion. The retainer has a weakened region between a region that attached to the trim cover and a region that extends into a slot in the seat cushion. The weakened region may be formed by reducing the thickness, such as by debossing (removing a layer of material), or by providing fewer layers. Alternatively or additionally, it may be formed by perforations along a fold line.

### CROSS-REFERENCE TO RELATED APPLICATIONS

This application claims foreign priority benefits under 35 U.S.C. § 119 (a)-(d) to Chinese application 2023115209729 filed Nov. 15, 2023, which is incorporated by reference in its entirety.

### TECHNICAL FIELD

The present disclosure relates to a vehicle seat. More particularly, it relates to a vehicle seat with a trim cover fastened to a seat cushion using a retainer with a weakened region.

### BRIEF DESCRIPTION OF THE DRAWINGS

FIG. 1 is a pictorial view of a vehicle seat assembly.

FIG. 2 is an exploded cross-sectional view of a vehicle seat assembly.

FIG. 3 is a cross sectional view of the seat assembly of FIG. 2.

FIG. 4 is a cross-sectional view of a vehicle seat assembly with a visible seam.

FIG. 5 is a cross sectional view of a vehicle seat assembly with a visible seam.

FIG. 6 is a pictorial view of a first embodiment of a retainer suitable for use in the seat assembly of FIG. 2.

FIG. 7 is a pictorial view of a second embodiment of a retainer suitable for use in the seat assembly of FIG. 2.

FIG. 8 is a cross-sectional view of the retainer of FIG. 7.

FIG. 9 is an exploded cross-sectional view of a vehicle seat assembly.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Except in the examples, or where otherwise expressly indicated, all numerical quantities in this description indicating amounts of material or conditions of reaction and/or use are to be understood as modified by the word “about” in describing the broadest scope of the invention. The term “substantially,” “generally,” or “about” may be used herein and may modify a value or relative characteristic disclosed or claimed. In such instances, “substantially,” “generally,” or “about” may signify that the value or relative characteristic it modifies is within +0%, 0.1%, 0.5%, 1%, 2%, 3%, 4%, 5% or 10% of the value or relative characteristic. Practice within the numerical limits stated is generally preferred.

It should also be appreciated that integer ranges (e.g., for measurements or dimensions) explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g. pressure, pH, flow rates etc.) can be practiced with plus or minus 50 percent of the values indicated rounded to three significant figures. In a refinement, concentrations, temperature, and reaction conditions (e.g., pressure, pH, flow rates, etc.) can be practiced with plus or minus 30 percent of the values indicated rounded to three significant figures of the value provided in the examples. In another refinement, concentrations, temperature, and reaction conditions (e.g., pressure, pH, flow rates, etc.) can be practiced with plus or minus 10 percent of the values indicated rounded to three significant figures of the value provided in the examples.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

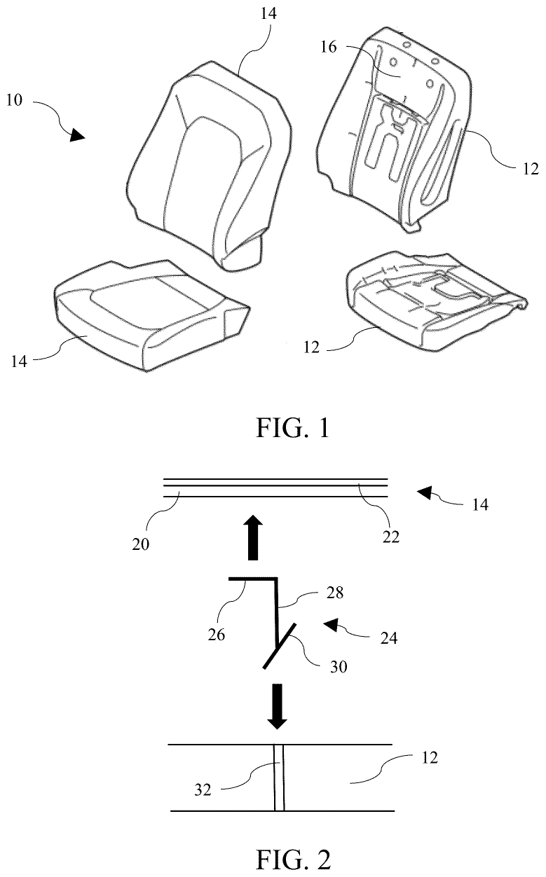

FIG. 1 is a pictorial view of a vehicle seat 10. The vehicle seat has one or more cushions 12 made of foam or other compressible, resilient material. A side of each of the cushions that faces the vehicle interior is covered with a trim cover 14. When the cushion surface is convex, the trim cover can be pulled tight and tends to stay in place. However, some cushions have a concave surface 16. In these situations, provisions must be made to hold the trim cover against the cushion surface.

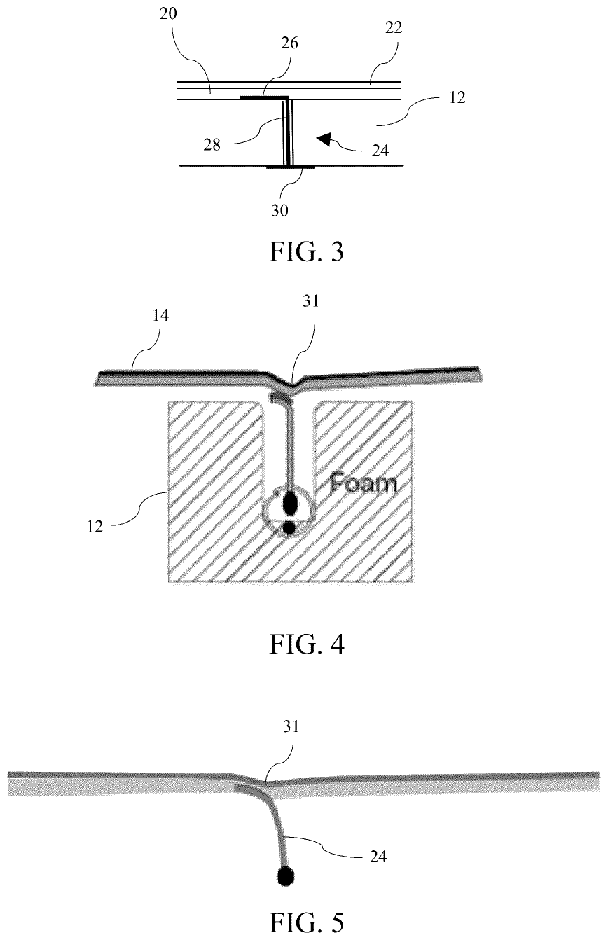

FIGS. 2 and 3 illustrate a method of fastening a trim cover to a seat cushion. The trim cover 14 may have multiple layers, such as a backing layer 20 and a finish layer 22. The finish layer may be leather, textile material, Poly-Vinyl Chloride (PVC), PolyUrethane, or other material. The trim cover is held to the cushion with a retainer 24. In the embodiment of FIGS. 2 and 3, the retainer includes a first region 26, a second region 28, and a paddle 30. The first region 26 is fastened to the backing layer of the trim cover by gluing, blind stitching, or other methods. The second region is pushed through a slot 32 in the seat cushion. The paddle is attached to a distal end of the second region. The paddle can be aligned with the second region while being pushed into the slot and then oriented perpendicular to the second region after insertion to hold the retainer in the slot as shown in FIG. 3. Ideally, the attachment should not be visible from the finished side of the trim cover and should not be felt by a seat occupant.

Prior to insertion in the slot, the retainer is bent such that the first region and the second region are at a right angle. In this context, any angle between 80 degrees and 100 degrees should be regarded as a right angle. In some embodiments, the angle may be between 70 and 110 degrees. More preferably, the angle may be between 85 and 95 degrees. The retainer 24 may have some resistance to being bent and staying bent. When this occurs, the first region does not lay flat against the surface of the cushion. This may result in a visible crease 31 in the trim cover as shown in FIGS. 4 and 5.

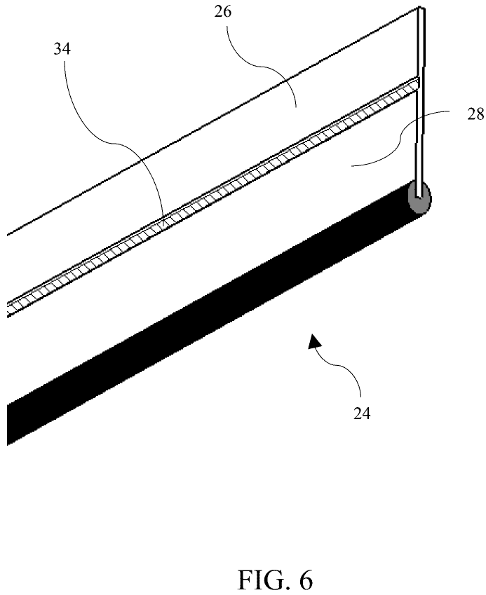

FIG. 6 illustrates a first embodiment of a retainer that is designed to avoid the visible crease issue. A weakened region 34 is located between the first region and the second region in the area that needs to be folded. The weakened region is formed by having reduced material thickness along the fold line. The material thickness may be reduced, for example, by debossing (removing material).

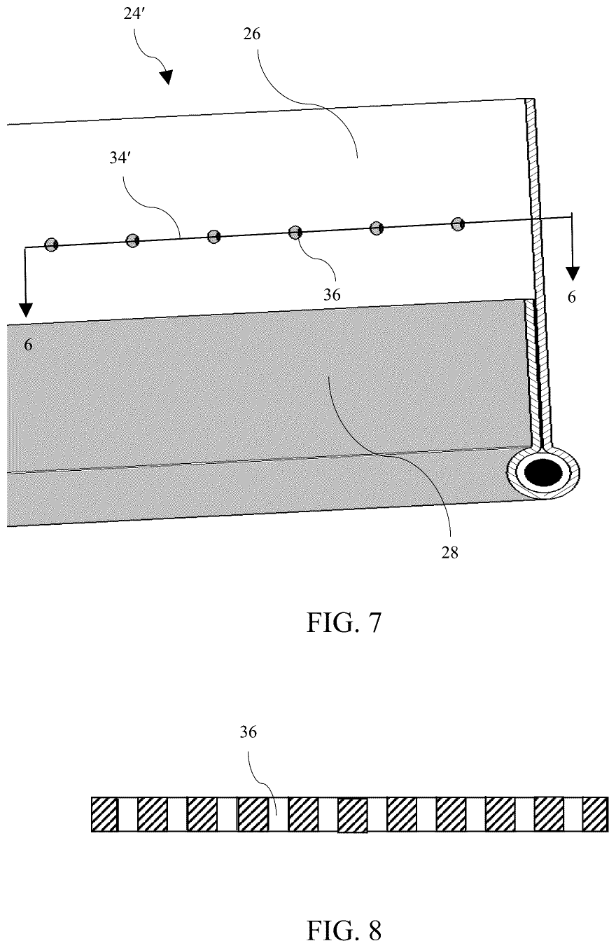

FIGS. 7 and 8 illustrate a second embodiment of a retainer 24′ that is designed to avoid the visible crease. In this embodiment, the weakened region is formed by perforating the retainer. A sequence of round holes 36 are formed along the fold line, although the shape of the holes is not critical. FIG. 8 is a cross-sectional view along the fold line. Additionally, the second region 28 is stiffer because it includes two layers of the material whereas the first region and the weakened region have only one layer. In some embodiments, the first region 26 may also have more layers than the weakened region.

One way to measure the effectiveness of weakening is to measure the stiffness (resistance to bending) of a segment of a fixed length in each region. Preferably the stiffness in the weakened region is less than one third of the stiffness in the first region and the second region. Another way to measure the effectiveness of weakening is based on relative cross-sectional areas. The cross-sectional area in the weakened region is shown by cross-hatching in FIG. 6. In the first and second regions, the cross-sectional area would not exclude the holes. In the first embodiment, the cross-sectional area along the fold line is reduced due to the removal of material. Preferably the cross-sectional area along the fold line is less than two thirds of the cross-sectional areas in the first and second regions.

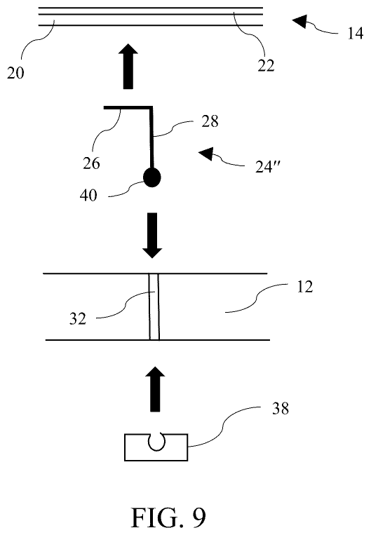

FIG. 9 describes an alternative embodiment of a retainer 24″. In this embodiment, instead of the paddle illustrated in the embodiment of FIGS. 2 and 3, a fastener 38 engages a feature 40 on the distal end of the second region. The fastener is attached to the retainer from the side of the cushion opposite the trim cover after the second region is inserted into the slot and prevents the retainer from withdrawing from the slot.

Aspect 1. An assembly, specifically a vehicle seat, includes a seat cushion, a trim cover, and a retainer. The seat cushion defines a slot. The trim cover is adjacent to the seat cushion. The retainer extends into the slot and is attached to the trim cover. The retainer includes a weakened region, to prevent visible deformation of the trim cover, between a first region that attaches to the trim cover and a second region that extends into the slot.

Aspect 2. The assembly of aspect 1, wherein a first cross sectional area of material within the weakened region is less than two-thirds of a second cross sectional area of material in the first region and also less than two-thirds of a third cross sectional area of material in the second region.

Aspect 3. The assembly of aspect 1 or 2, wherein a first stiffness of the weakened region is less than one third of a second stiffness of the first region and also less than one third of a third stiffness of the second region.

Aspect 4. The assembly of any of aspects 1 to 3, wherein the weakened region includes at least one perforation line.

Aspect 5. The assembly of any of aspects 1 to 3, wherein the weakened region is formed by debossing.

Aspect 6. The assembly of any of aspects 1 to 5, wherein the trim cover and the first region of the retainer are parallel.

Aspect 7. The assembly of aspect 6, wherein the trim cover and the first region of the retainer are attached to one another using glue.

Aspect 8. The assembly of aspect 6, wherein the trim cover and the first region of the retainer are attached to one another using blind stitching.

Aspect 9. The assembly of any of aspects 6 to 8, wherein an angle between the first region of the retainer and the second region of the retainer is between 70 degrees and 110 degrees.

Aspect 10. The assembly of aspect 9, wherein the angle is between 80 degrees and 100 degrees.

Aspect 11. The assembly of aspect 10, wherein the angle is between 85 degrees and 95 degrees.

Aspect 12. The assembly of any of aspects 1 to 11, wherein the trim cover comprises leather.

Aspect 13. The assembly of any of aspects 1 to 11, wherein the trim cover comprises a textile material.

Aspect 14. The assembly of any of aspects 1 to 11, wherein the trim cover comprises Poly-Vinyl Chloride (PVC).

Aspect 15. The assembly of any of aspects 1 to 11, wherein the trim cover comprises PolyUrethane.

Aspect 16. The assembly of any of aspects 1 to 15, wherein the retainer further comprises a paddle attached to a distal end of the second region, the paddle holding the retainer in the slot.

Aspect 17. An assembly, specifically a vehicle seat, includes a seat cushion, a trim cover, and a retainer. The seat cushion defines a slot. The trim cover is adjacent to the seat cushion. The retainer is attached to the trim cover and extends into the slot. The retainer is folded at a right angle along a fold line. A first cross sectional area of material along the fold line is less than a second cross sectional area of material along a first line parallel to and adjacent to a first side of the fold line and also less than a third cross sectional area of material along a second line parallel to and adjacent to a second side of the fold line.

Aspect 18. A method includes forming a fold line in a retainer, attaching a first portion of the retainer on a first side of the fold line to a trim cover, inserting a second portion of the retainer on a second side of the fold line into a seat cushion, and fixing the second portion with respect to the seat cushion.

Aspect 19. The method of aspect 18 also includes folding the retainer without visibly deforming the trim cover.

Aspect 20. The method of aspect 18 or 19 wherein fixing the second portion with respect to the seat cushion includes, after inserting the second portion of the retainer into the seat cushion, fastening a distal end of the second portion to an object on an opposite side of the seat cushion from the trim cover.

Further aspects are also contemplated, consistent with the above disclosed embodiments and their combinations.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. An assembly comprising:
a seat cushion defining a slot;
a trim cover adjacent to the seat cushion; and
a retainer extending into the slot and attached to the trim cover, the retainer comprising a weakened region between a first region that attaches to the trim cover and a second region that extends into the slot.

2. The assembly of claim 1, wherein a first cross sectional area of material within the weakened region is less than two-thirds of a second cross sectional area of material in the first region and also less than two-thirds of a third cross sectional area of material in the second region.

3. The assembly of claim 1, wherein a first stiffness of the weakened region is less than one third of a second stiffness of the first region and also less than one third of a third stiffness of the second region.

4. The assembly of claim 1, wherein the weakened region comprises at least one perforation line.

5. The assembly of claim 1, wherein the weakened region is formed by debossing.

6. The assembly of claim 1, wherein the trim cover and the first region of the retainer are parallel.

7. The assembly of claim 6, wherein the trim cover and the first region of the retainer are attached to one another using glue.

8. The assembly of claim 6, wherein the trim cover and the first region of the retainer are attached to one another using blind stitching.

9. The assembly of claim 6 wherein an angle between the first region of the retainer and the second region of the retainer is between 70 degrees and 110 degrees.

10. The assembly of claim 9, wherein the angle is between 80 degrees and 100 degrees.

11. The assembly of claim 10, wherein the angle is between 85 degrees and 95 degrees.

12. The assembly of claim 1, wherein the trim cover comprises leather.

13. The assembly of claim 1, wherein the trim cover comprises a textile material.

14. The assembly of claim 1, wherein the trim cover comprises Poly-Vinyl Chloride (PVC).

15. The assembly of claim 1, wherein the trim cover comprises PolyUrethane.

16. The assembly of claim 1, wherein the retainer further comprises a paddle attached to a distal end of the second region, the paddle holding the retainer in the slot.

17. An assembly comprising:
a seat cushion defining a slot;
a trim cover adjacent to the seat cushion; and
a retainer attached to the trim cover and extending into the slot, the retainer folded at a right angle along a fold line, wherein a first cross sectional area of material along the fold line is less than a second cross sectional area of material along a first line parallel to and adjacent to a first side of the fold line and also less than a third cross sectional area of material along a second line parallel to and adjacent to a second side of the fold line.

18. A method comprising:
forming a fold line in a retainer;
attaching a first portion of the retainer on a first side of the fold line to a trim cover;
inserting a second portion of the retainer on a second side of the fold line into a seat cushion; and
fixing the second portion with respect to the seat cushion.

19. The method of claim 18 further comprising folding the retainer without visibly deforming the trim cover.

20. The method of claim 18 wherein fixing the second portion with respect to the seat cushion comprises, after inserting the second portion of the retainer into the seat cushion, fastening a distal end of the second portion to an object on an opposite side of the seat cushion from the trim cover.
